(19) United States
(12) Patent Application Publication
(10) Pub. No.: US 2006/0142172 A1
(43) Pub. Date: Jun. 29, 2006

(54) Cleaning compositions for oil-gas wells, well lines, casings, equipment, storage tanks, etc., and method of use

(76) Inventors: Kenneth R Cioletti, Wayne, NJ (US); Prakash N Maniar, Northvale, NJ (US); Ronald Wilen, Paramus, NJ (US)

Correspondence Address: GREENBERG TRAURIG, LLP, MET LIFE BUILDING, 200 PARK AVENUE, NEW YORK, NY, 10166, US

(21) Appl. No.: 10/532,011

(22) PCT Filed: Oct. 21, 2003
(86) PCT No.: PCT/US03/33346

§ 371 Date: Oct. 17, 2005

Related U.S. Application Data
(60) Provisional application No. 60/419,913, filed on Oct. 21, 2002.
(60) Provisional application No. 60/449,223, filed on Feb. 20, 2003.
(60) Provisional application No. 60/488,837, filed on Jul. 21, 2003.

(51) Int. Cl. C11D 3/20

(52) U.S. Cl. 510/365

(57) ABSTRACT

The invention relates to a high flash point aromatic, aliphatic hydrocarbon petroleum solvents optionally combined with specific ingredients to provide maximum solvency, penetration, saturation, dissipation and dispersion of the solid deposits. It has very low evaporation, high flash point (>100° F.), low freezing pour point, corrosion protection and increased cleaning efficiency.

### FIELD OF THE INVENTION

The invention relates to the removal and remediation of deposits, such as, paraffins, asphaltenes and gas hydrates associated with underground formations, flow lines, pipes, coatings, tanks, including tank bottoms, and the like using chemical compositions.

### BACKGROUND OF THE INVENTION

The efficient recovery of oil and gas from working oil or gas wells, tanks or flow or pipelines depends on maintaining clean lines and pumping equipment. Oil wells have problems with the build up of paraffin, sulfur, heavy oil, and tar by-products. These residues foul the lines that carry the oil and gas to the surface and foul the pumps and metal rods of equipment, used in recovering the oil and gas from wells.

Typical prior art methods for such cleaning consist of four major types of products. A first method uses aggressive blends of low flash point blends of aromatic and/or aliphatic petroleum hydrocarbons or halogenated hydrocarbons. These products may or may not contain surfactants to allow the products to mix with and emulsify in water to increase cleaning efficiency. The presence of water decreases the efficiency of these products significantly. Pure solvent blends are immiscible in water and cannot penetrate to the soils. The addition of emulsifiers allows the solvents to blend with the water. However, the resulting solvent/emulsion system is not as efficient a cleaner as the pure solvent.

A second method uses of bacteria to digest the paraffinic and tar-based soils. This system is very dependent on well temperature and is sensitive to environmental factors such as the composition of the oil. This process is typically slower than solvent-based processes.

A third method is predicated on water-based alkaline, hard-surface cleaners. These cleaners generally incorporate alkaline builders, water-soluble solvents, such as glycol ethers, alcohols, and surfactants. Alkaline builders consist of hydroxides, carbonates, phosphates, and silicates. Water-soluble solvents typically consist of ethylene glycol, diethylene glycol, propylene glycol and dipropylene glycol ethers. Typical ethers are the categories of alkyl phenol ethoxylates, linear alcohol ethoxylates, alkyl or aryl sulfonates, amphoterics, and fatty acid soaps of alkanolamides. The cleaning efficiency of these alkaline products on paraffins and other oil-based soils is typically much lower than that of solvent blends.

A fourth method of cleaning involves the use of hot oil which is injected into the well. The hot oil melts and dissolves the paraffins and carries them to the surface. Although this method is very efficient, the use of hot oil creates a hazardous condition.

There are many problems associated with the above-mentioned solvents. For example, halogenated hydrocarbons affect worker health adversely and are ozone-depleting chemicals. Many of the non-halogenated solvents used are either flammable or combustible, resulting in increased fire and explosion risks and higher insurance premiums. Furthermore, the disposal of the spent solvents, in accordance with government regulations, is expensive. In fact, most of the halogenated solvents are subject to high taxes and are in the process of being phased out.

In addition to the above-mentioned problems, recent government legislation severely limits the amount of volatile organic compounds (VOCs) that may be emitted into the atmosphere. These limits are set by the Environmental Protection Agency, as specified by the “Clean Air Act,” and are determined by the solvent content of the incoming production of raw material versus the solvent content of the waste or finished products.

The bacteria-based cleaning solution also has other disadvantages. The treatment requires that the well be shut down for several weeks to allow the establishment of a bacterial colony. When pumping is resumed, the bacteria are removed with the oil, which results in rapid depletion of the bacteria colony and this leads to the need for further treatment.

There are many different global geographical locations with seasonal effects and temperature variances that tend to affect Theological changes which are much more pronounced at relatively lower ambient temperature. For example, deep water offshore wells and flow lines, which are often submerged at about 300+feet and exhibit low ambient temperatures of 40-45° F. are more prone to viscosity buildups due to paraffin crystallization and hydrates formation causing lengthy down time for clean-ups.

During crude recovery it is vital to remove and dissipate such solid deposits of the processing equipment, flow lines, well formation, casings and also the storages and tank bottoms to maintain production efficiency and utilization for an optimum production.

There are conventional treatments and remediation available and utilized for such applications. For example, organic solvents such as aliphatic and/or aromatic hydrocarbons (HC's), C₁-C₅ alkyl esters of aliphatic fatty C₅-C₂₂ monocarboxylic acids used alone or in combination with other chemical compounds for such removal and/or remediation. However, such means may not be optimum and often unacceptable due to one ore more of the following properties:

Severe safety hazards e.g. fire, health & reactivity

Ecological set backs

Storage and transport conditions

Overall applicability and competitive features

Fire hazards due to low flash pt and high explosion risk

Health due to toxicity, corrosion and reactivity

Transport DOT regulation compliance

Freezing point and Pour point not low enough.

Also such solvents, when applied singularly, lack overall solvency and in blends result in one or more of above restrictive features.

### SUMMARY OF THE INVENTION

There are many types of soils which buildup in gas and oil wells and processing equipment, such as paraffins, tar by-products, and other viscous soils. Further, the buildup of scale is a problem in such wells and equipment. Scale is typically, but not limited to, the accumulation of calcium carbonate deposits and/or iron oxide and other hard residual deposits. The composition of the present invention is effective to remove many types of soils and scale associated with gas and oil recovery and processing and thus enhance the oil recovery process.

The present invention relates to a chemical composition, which is specifically formulated to overcome one or more of the above inadequacies. Laboratory experiments have demonstrated good efficiency for embodiments of the this invention as well as multi-functional universal features in comparison with current commercially available and applicable techniques with economical benefits as an added advantage.

The present cleaning compositions provide excellent wetting ability, dispersibility and solvency for an effective removal of deposits. These compositions work to dissolve deposits at low concentrations and limited contact time. Embodiments of the present invention can be used in extreme temperature ranges, i.e., for example -about 40° C. to about 230° F. and have low emulsifying tendencies with brine water.

An embodiment of this invention comprises a composition and method for removing oils, paraffins, and other related soils and asphaltene deposits from underground formations, oil containing structures, oil conducting structures and oil processing equipment by injecting into such locations a cleaning composition comprising about 1-99% by weight of a low naphthalene (C10-C15) aromatic solvent blend with tag closed cup flash point >100° F. and about 1-40% by weight of at least one C12-C15 high flash naptha.

Another embodiment of the present invention is a composition and method of preventing the adhesion and accumulation of paraffins, soils and other deposits comprising coating the inner surfaces of oil processing equipment with a composition further comprising about 1 to 25 wt. % of a fatty acid alkyl ester blend.

### DETAILED DESCRIPTION OF THE INVENTION

Embodiments of the present cleaning composition can comprise:
a) a mixture of organic solvents wherein the mixture comprises reduced naphthalene aromatic solvents, aliphatic petroleum distillates and normal and cycloaliphatic naphthla usually in an amount of up to about 70% by weight.

These compositions can further comprise:
b) up to about 25% by weight of at least the one alkyl ester of a fatty acid;
c) up to about 10% by weight of at least one of a surfactant, and emulsifier, a wetting agent, a penetrating agent, a chelating agent, and a coupling agent; and
d) up to about 10% by weight of an alkylene glycol alkyl ether.

The total amount of the components of the composition comprise 100% by weight of the composition.

Viscosity reduction and flow enhancement i.e. pumpability can be enhanced by incorporation and/or utilization of a polymeric drag reducer or oil friction reducer. Examples of such materials include, for example, OFR-2 a high molecular weight synthetic polymer sold by Clearwater; FRA-700 a very high molecular weight, anionic polymeric suspension also sold by Clearwater; FRA-175 a high molecular weight polyacrylamide also sold by Clearwater. These flow enhancers can comprise polyolefin moieties and may contain non-olefin olefin units. The flow enhancers have a molecular weight sufficiently high to allow the polymers to reduce fluid flow drag. Suitable polymers may have molecular weights of about 1 million Daltons and higher and up to 25 million Daltons.

The low naphthalene aromatic solvent blends useful in compositions of this present invention, preferably contain C₁₀-C₁₅ aromatic hydrocarbon compounds with flash points above 100° F. preferably 150° F. or greater. Exemplary types of aromatic solvents which may be utilized are Aromatic 100ND, Aromatic 150ND or Aromatic 200ND (products of Exxon Mobil) with 1% Naphthalene and <50 ppm toluene and Aromatic 200 super ND with 0.1% naphthalene and, 50 ppm toluene.

The aliphatic blends useful in composition of the present invention are preferably C₁₂-C₁₅ ISO or cyclo paraffinic napthas with flash point above about 200° F.

In addition a C₁₀-C₁₅ Isoparaffinic composition can also used to increase solvency of the paraffins.

The additives of the composition comprise, for example, but are not limited to the following:

In general, the present compositions include up to about 25% by weight of C₁ to C₈ alkyl esters of C₄ to C₂₂ fatty acids having the general formula:

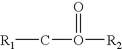

in which R₁ is a C₄ to C₂₂ straight chain or branched hydrocarbon radical which can be saturated or can contain unsaturation and R₂ is a C₁ to C₈ straight chain or branched chain alkyl radical. Fatty acid esters are derived from natural products, and thus comprise more than one ester; hence blend. Typically, fatty acid esters are derived from the esterification of fatty acids or the transesterification of animal fats or vegetable oils.

The fatty acid alkyl ester blend more preferably contains methyl, ethyl, n-propyl, isopropyl, or n-butyl esters of C₄ to C₂ fatty acids. Most preferably, the fatty acid alkyl ester blend contains methyl esters. The fatty acid methyl ester blends are preferably blends with a cloud point of 40° F. and a high degree of unsaturation to increase solvency. More preferably, the fatty acid methyl ester blends are derived from soya, canola, and other vegetable oils, with a cloud point of 20°-32° F. and an iodine value of 90-130.

A Surfactant may also be added to the composition which is suitable for use in cleaning oily and greasy soils such as, for example, ethoxylated nonylphenols.

Linear alcohol ethoxylates. Alkanolamine salts of dodecyl benzene sulfonic acid sulfosuccinates, phosphate esters. Alcohol Sulfate, Quaternary Ammonium compounds amphoteric surfactants, Alpha olefin sulfonates. Sorbitan and fatty acid derivatives, sodium xylene sulfonates.

Exxate 900, 1000 and 1200 and acetic acid esters of C9-C12 branched oxo-alcohols.

DBE (Dupont) is a blend of 45-75 weight % Dimethyl Glutarate 10-75% weight % Dimethyl adipate and 15-30 weight % Dimethyl succinate.

Up to 20% of a lower alkyl alcohol ester may be added as a peneterant, as a coupling agent and/or to increase efficacy on hydrophilic soils. Examples of lower alkyl glycol ethers useful in the present composition include dipropylene glycol monomethyl ether, tripropylene glycol monomethyl ether, ethylene and diethylene glycol, methyl, ethyl, propyl and butyl ethers or mixture thereof. Also found useful as a peneterant is N-methylpyrrolidone.

In general, embodiments of this invention can comprise:
Up to 25% by volume of C6 or higher alkyl esters of a fatty acid;
Functional additives such as surfactants, emulsifiers, as wetting and penetrating agents, chelation and coupling agents up to 10% by volume with HLB values between 8-15 exhibiting specific improvements;
Organic solvent blends for example up to about 70% by volume comprising petroleum distillates hydrocarbons aliphatics, aromatic, alicyclic, glycol ethers & esters with strong solvency and non-hazardous characteristic;
Other compounds which impart specific characteristics and enhance specific property such as KB/HLB values for extra strength, wetting, penetrating and solubilizing heavy and stringent hard deposits; or
For enhanced solvency and versatile applicability and chemical compatibility a polymeric drag reducer with suitable compounds for improved and lasting drag resistance.

A significant aspect of the current invention is the expedient removal & remediation of the heavy solid deposits and clogged lines with phenomenal reduction in soak/well time for the chemical treatments. For example, with the current-method a soak cycle can be reduced from 24-72 hrs. down to 4-8 hrs.

A lower alkyl glycol ether may be added as a penetrant, to reduce viscosity of the mixture, as a coupling agent, and/or to increase efficacy on hydrophilic soils. Examples of lower alkyl glycol ethers useful in the present composition include dipropylene glycol monomethyl ether, tripropylene glycol monomethyl ether, ethylene and diethylene glycol ether, methyl, ethyl, propyl and butyl ethers, such as ethylene glycol monobutyl ether, or mixtures thereof.

A polyxyalkylene glycol ether may be present in the composition. The actual amount utilized depends on the types of soil present in the equipment to be cleaned and on the water content of the well or equipment being cleaned. Preferably used are polyethylene glycol ethers and polypropylene glycol ethers having the formulas:
R—O—(C₂H₄O)ₓH and R—O—(C₃H₆O)ₓH
where, in each formula, R is C₁ to C₈ alkyl and x is greater than 4. R is preferably methyl, ethyl, propyl, or butyl. More preferably, the polyoxyalkylene glycol ether is an n-butoxy polyalkylene glycol ether. Commercial polyoxyalcylene glycol ether formulations available include Macol 300, Macol 660, WSL-2000, WSL-3520, and WSL-5100 produced by PPG Mazer, Gurnee, Ill. The polyoxyalkylene glycol ether preferably has a molecular weight of between about 200 and 600 and a viscosity of between about 15 and 150 cps when measured at 25° C. using a Brookfield LVT Viscometer with a No. 2 spindle at 60 r.p.m.

Antioxidants can be included in the composition. Antioxidants suitable for the present invention include, but are not limited to, (BHT) 2,6di-tert-butyl-para-cresol, (BHA) 2,6-di-tert-butyl-para-anisole, Eastman inhibitor OABM-oxayl bis(benzylidenehydrazide), and Eastman DTBMA 2,6-di-tert-butylhydroquinone. The surfactant is added in an amount effective to perform as a wetting agent and emulsifier.

Commercial surfactants include the EXXATE series of surfactants obtained from EXXON. EXXATE 1000 is an acetic acid ester of C₉-C₁₁ branched oxo-alcohol. DBE (DuPont) is a blend of 45-75 wt. % dimethyl glutarate, 10-25 wt. % dimethyl adipate, and 15-30 wt. % dimethyl succinate.

Other additives may be added, as needed, for particular applications, such as to increase penetration of the mixture, decrease viscosity of the mixture, as couplers for solvents insoluble in the mixture, and to provide solvents for oleophilic and hydrophilic soils. It is within the skill of the art to determine the amount and type of additive needed for a particular application.

The present invention is further directed to methods for removing and preventing the buildup of paraffins, other related soils, and scale from gas and oil wells, hydrocarbon bearing formations, and recovery, pumping, storage, and transmission equipment by injecting into the wells and such equipment a cleaning composition.

There are many types of soils which buildup in gas and oil wells and processing equipment, such as paraffins, tar by-products, and other viscous soils. Further, the buildup of scale is a problem in such wells and equipment. Scale is typically, but not limited to the accumulation of calcium carbonate deposits and/or iron oxide and other hard residual deposits. The composition of the present invention is effective to remove many types of soils and scale associated with gas and oil recovery and processing and thus enhance the oil recovery process.

The gas and oil processing equipment includes all types and varieties of equipment associated with gas and oil recovery and processing, for example, gas and oil well casings, pumps, pipes, lines, tanks, and the like. It is contemplated that the present composition may be used with all such equipment.

There are several ways that the method of removing or preventing soils and/or scale buildup in gas and oil wells and equipment may be implemented using a composition in accordance with the present invention.

In addition to cleaning the wells and associate equipment, it is often desirable to introduce the composition, through the perforations in the casing, into the surrounding formation. The composition may be forced into the surrounding formation by applied pressure or, if the composition is allowed to set at the bottom of the casing, the composition may seep into the formation without additional pressure. The composition permeates the formation, dissolving blockages in the formation to provide more efficient oil and gas recovery.

A method of cleaning and maintaining a working well, including the surrounding formation, includes the steps of pouring or injecting the composition down the casing side (back lines) of a well and allowing it to mix with the fluid which is already in the well. When enough fluid is present, the composition is then circulated by a pump for 24-72 hours, preferably 48-72 hours. Prior to circulating, the composition may be allowed to set for 8 to 24 hours, for example. The setting time, circulating time and dosage depend on the amount of soil and/or scale anticipated to be present as well as the depth of the well. A basic initial dosage can be, but is not limited to, 20 gallons of composition and for maintaining a clear structure, at least about 5 gallons of composition per well on periodic basis, e.g. biweekly, monthly, bimonthly.

The composition may also be applied directly to the equipment. For example, prior to placing rods and casings into gas and/or wells, these parts may be sprayed with the composition, or the parts may be dipped into tanks filled with the composition to prevent corrosion and buildup of scale and soils.

The composition may be introduced by means of injection pumps into off-shore gas or oil wells to reduce soils, particularly paraffin, or scale adhesion in well casings and transmission lines. In addition to the problems associated with land oil wells, off shore wells have the further problem of the ocean or sea water behaving as coolant of the lines and contents between the bottom of the ocean the platform. Thus off shore wells have a particular problem with paraffin buildup. To treat the lines, 40-50 gallons, for example, of the composition, for example, are dropped into the lines.

The composition used in the methods of the claimed invention can contain ingredients in amounts effective to clean the wells, formations, and equipment and/or to provide an effective coating on their surfaces to prevent future buildup of soils and scale and corrosion.

An embodiment of the present composition comprises:

| Ingredients | | W/W % & Range | |
|---|---|---|---|
| C10-C15 | Aromatic 200ND | 40.0 | 10-70 |
| | (Flash 200 F.; Napthelene < | | |
| | .04; Toluene < 20-0 ppm) | | |
| C12-C15 | Aliphatic petroleum distillates | 30.0 | 10-55 |
| | Iso, Cyclo paraffinic hi flash Naptha | | |
| C11-C16 | Normal & Cyclo paraffinic Naptha | 5.0 | 1-8 |
| C8-C18 | fatty acid Methyl | 7.0 | 2-20 |
| | ester | | |
| DPnB | Di-propylene glycol n-butyl ether | 5.0 | 1-10 |
| EDTA | ethylene diamine Tetracetic acid | 1.0 | 0.1-2.0 |
| | Chelating & Wetting | | |

| | | |
|---|---|---|
| Sodium Xylene Sulfonate (40-45%) | 1.0 | 0.1-2.0 |
| C-21 dibasic fatty acid, potassium salt | 1.0 | 0.1-2.0 |
| TEA Triethanol Amine | 0.70 | 0.1-1.5 |
| D-Limonene | 1.0 | 0.1-1.5 |
| Nonyl phenol, 9-mole ethoxylate (surfactant) | 1.0 | 0.1-1.5 |
| N-Methyl 2-Pyrolidone. (peneterant) | 6.50 | 1.0-10.0 |

A second example is as follows:

| | | | C-Chain |
|---|---|---|---|
| Ingredients & Description | W/W % | Range | & Chem. |
| AROMATIC 150ND | 60 | 15-75 | C-10-C-15 |
| (Naphthalene Depleted) | | | |
| Flash pt. 150° F. | | | |
| HT 142 Naptha Flash | 30.5 | 10-60 | C-12-C-15 |
| pt. < 150° F. Aliphatic | | | |
| Petroleum Distillate | | | |
| *(Iso& cyclo Paraffins) | | | |
| Amines n-tallow | 0-25 | 1-25 | |
| alkyltrimethylene dioleates | | | |
| (corrosion Inhibitor) | | | |
| OFR-OZ OIL | 2.0 | 1-10 | |
| FRICTION REDUCER Hi | | | |
| moleculor wt. | | | |
| Polymeric Film former | | | |
| KH-30 | 5.0 | 1-20 | C-1 Alkyd |
| Plus a small concen- | | | C8-C18 |
| tration of surfactant, | | | F.A. este |
| chelating & Glycol | | | |
| coupling agents | | | |
| Surfynol 440 | 0.25 | 1-2.5 | |

There are many types of soils associated with oil processing equipment, such as oils, paraffins, sulfur, tar by-products, and other viscous soils. The composition of the present invention is effective to remove all types of soils associated with oil recovery and processing.

The oil processing equipment includes all types and varieties of equipment associated with oil recovery and processing, for example, oil well equipment, oil well casings, pumps, conduits, lines and the like. It is contemplated that the present composition may be used with all such equipment.

The method for removing oils, paraffins, and other related soils and the coating of the surfaces of oil processing equipment can be achieved together. That is, the equipment may be cleaned and treated simultaneously. The compositions used in the methods of the claimed invention contain ingredients in amounts effective to clean the equipment and/or to provide an effective treatment to inhibit solid buildups.

Up to 50 wt. % of additives may be added, as needed, for particular applications, such as to vary the VOC levels, increase penetration of the mixture, decrease viscosity of the mixture, as couplers for solvent insolubles in the mixture, and to provide solvents for oleophilic and hydrophilic soils. Suitable additives include terpenes, terpene alcohols, C8-C14 alcohol ester blends, glycols, glycol ethers, acid esters, diacid esters, petroleum hydrocarbons, amino acids, alkanolamines, and amines, preferably, methyl or isobutyl esters of C4-C6 aliphatic dibasic esters and n-methyl-2 pyrolidone.

Examples of terpenes include d-limonene and α and β pinene and terpene alcohols, including a terpineol. C8-C14 alcohol ester blends include EXXATE 900, 1000, 1200 from Exxon Chemical; glycols include propylene glycol, dipropylene glycol, and triproplylene glycol; and glycol ethers include dipropylene glycol monomethyl ether, propylene glycol monomethyl ether, propylene glycol-n-butyl ether, ethylene glycol monobutyl ether, and diethylene glycol monbutyl ether. Acid esters include methyl oleate and methyl linoleate, and diacid esters include methyl or butyl diesters of glutaric, adipic, and succinic acids. Petroleum hydrocarbons include AROMATIC 100, AROMATIC 150 ISOPAR M, and ISOPAR K.

Amines such as morpholine, 1,3-dimethyl-2-imidazolidinone, 1, 3-propanediamine, 2-amino-1,3-propanediol, and 3-amino propanol, and alkanolamines such as triethanolamine, diethanolamine, 2-aminomethyl propanol, and monoethanolamine act as dispersants for soils and solubilize fatty acids and oils. Amino acids, provide nontoxic alternatives to monoethanolamine, and act as metal chelators. Methyl or isobutylesters of C4-C6 aliphatic dibasic esters and n-methyl-2 pyrolidone are also useful.

Other additives typically used in cleaning compositions may be used, including water softening agents, sequesterants, corrosion inhibitors, and antioxidants, which are added in amounts effective to perform their intended function. These additives and amounts thereof are well within the skill of the art. Suitable water softening agents include linear phosphates, styrene-maleic acid co-polymers, and polyacrylates. Suitable sequesterants include 1,3-dimethyl-2-immidazolidinone, 1-phenyl-3-isoheptyl-1,3-propanedione, and 2 hydroxy-5-nonylacetophenoneoxime. Examples of corrosion inhibitors include 2-aminomethyl propanol, diethylethanolamine benzotraizole, and methyl benzotriazole. Antioxidants suitable for the present invention include (BHT) 2,6-di-tert-butyl-para-cresol, (BHA) 2,6-di-tert-butyl-para-anisole, Eastman inhibitor O A BM-oxalyl bis (benzylidenehydrazide), and Eastman DTBMA 2,5-di-tert-butylhydroquinone.

All additives should have a flash point greater than 100° F., preferably greater than 150° F. and more preferably 195° F. TCC in order to achieve a final product flash point greater than 200° F.

Typical treatment of wells requires pumping the cleaning composition into the well casing followed by diesel oil or lease oil. The oil and composition may be mixed by any appropriate means and the mixture circulated for several hours to loosen Paraffin-Asphaltene deposits.

### EXAMPLES

The following composition was mixed for testing.

| | Weight % |
|---|---|
| Aromatic 200ND | 40.0 |
| Exxol D-95 | 30.0 |
| Isopar M | 5.0 |
| Soya methyl esters | 7.0 |
| Dispropylene glycol n-Butylether | 5.0 |
| Ethylene Diamine Tetra Acetic Acid | 1.0 |
| Sodium Xylene Suffinate (40%) | 1.0 |
| Tolytriazole | 0.5 |
| Triethanol Amine | 0.7 |
| Butylated hydroxy Tolene | 0.3 |
| D. Limonine | 2.0 |
| Nonylphenol 9 mole ethoxylate | 1.0 |

Other applications include but are not limited to oil pipe line, flow lines, storage tanks and subsurface underwater lines.

A typical sample of paraffin, which was blocking a well, was analyzed with the following break-down:

| | | |
|---|---|---|
| 1. | Neutral resins and moderate paraffins | 32.66% |
| 2. | Asphaltens | 13.53% |
| 3. | Volatiles | 26.54% |
| 4. | Scales and Minerals | 26.57% |

Into a 250 ml screw top jar place 5 gms of paraffin asphaltene paste. Sample and add 100 ml of the composition. The screw top was replaced and the jar was agitated for 1 minute. At the end of the mixing the jar was examined and it was found that paraffin/asphaltene blend was completely dispersed.

In a second embodiment, applicants have found that the addition of a polymeric film former such as, for example, OFR-2, can lead to a composition which effectively reduces friction pressure of petroleum crude in turbulent flow through pipelines for the retention of an original laminar flow. As a result an increase in flow rate and productivity with reduced energy consumption can be realized.

Lab experiments conducted on a Loop Test instrument by inserting a clogged line exhibited a very significant reduction in drag by measuring a differential pressure with and without a chemical treatment to a base fluid in a dosage range of 0.50%-2.0%.

Also a Substantial reduction in the viscosity of heavy crude was established by measuring rheological changes on the Brookfield viscometer within the same dosage levels of 0.5%-2.0%.

The distinct improvements in the protective barrier film were detected for both, the paraffin and asphaltenes with increased shelf-life as examined on carbon steel and related materials of construction.

Some examples of second embodiment formulations are as follows:

Formulations

| Chemical Ingredients | WW % |
|---|---|
| Example 1 | |
| Aromatic ND-200 | 93.0 |
| KH-30 | 5.0 |
| OFR-2 | 2.0 |
| Total | 100.0 |
| Example 2 | |
| Exsol D 110 | 45 |
| Aromatic 200 | 45 |
| KH-30 | 8 |
| OFR-2 | 2 |
| Total | 100.0 |

KH-30 comprises a C₁-C₄ alkyl C₈-C₁₈ fatty acid ester, an alkyl glycol ether and optionally a polyoxyalkylene glycol ether.

While particular embodiments of the present invention have been described and illustrated, it should be understood that the invention is not limited thereto since modifications may be made by persons skilled in the arts. Therefore the present application contemplates any and all modifications that fall within the spirit and scope of the underlying invention disclosure and claimed herein.

1. A composition for removing paraffin, heavy asphaltenes, oils, and other soils from oil wells and oil processing equipment comprising about 1 to 50% of a C₁₀-C₁₅ naphthalene depleted aromatic solvent blend containing less than 1% Naphthalene and less than 50 ppm toluene with a flash point about 100° and up to 10-50% of other additives.

2. A composition according to claim 1 wherein the additives comprise a fatty acid alkyl ester blend.

3. A composition according to claim 1 further comprising up to 20% or lower alkyl glycol ethers.

4. A composition according to claim 3 where in the lower alkyl glycol ether is dipropylene glycol n-butyl ether, dipropylene glycol monomethyl ether, tripropylene glycol monomethyl ether, propylene glycol no-butyl ether or mixture thereof.

5. A composition according to claim 1 further comprising up to 20 weight % of at least one additive selected from the group consisting of terpenes, terpene alcohols, C₈-C₁₄ alcohol acetate ester blends, glycols, diacid esters and n-methyl 2 pyrolidone.

6. A composition according to claim 1 further comprising up to 10% of a surfactants.

7. A composition according to claim 6 where in the surfactant is selected from the group of ethoxylated nonylphenols, linear alcohol ethoxylate and alkynolamine salts of dodecyl benzene sulfonic acid.

8. A composition according to claim 1 wherein the additives from the following categories are included to aid in longevity and performance, the additives include but are not limited to chelating agents such as EDTA coupling agents such as sodium xylene sulfonate, corrosion inhibitors such as methyl benzothiazole, antioxidants such as butylated hydroxyl toluene.

9. A composition according to any of claims 1 to 8 further comprising a polymeric film former, such as, OFR-2.

10. A composition according to claim 9 wherein the aromatic solvent blend has a flashpoint above 150° F.

11. A composition according to claim 9 wherein the aromatic solvent blend has a flashpoint above 200° F.

12. A method for removing and preventing the buildup of paraffin, tars, heavy oil, calcium carbonate, iron oxide and other soils and scales, from gas or oil wells, hydrocarbon bearing formations, or recovery, pumping, storage, or transmission equipment, comprising introducing into said well, formation, or equipment a composition according to claim 11.

13. A method for removing and preventing deposits from gas or oil wells, hydrocarbon bearing formations, or recovery, pumping, storage, or transmission equipment, comprising introducing into said well, formation, or equipment a composition according to claim 11.
